(19) United States
(12) Patent Application Publication
(10) Pub. No.: US 2007/0282656 A1
(43) Pub. Date: Dec. 6, 2007

(54) Dynamic appointment tracking

(76) Inventors: Jeffery Battcher, Macon, GA (US); Robert A. Koch, Norcross, GA (US)

Correspondence Address: THOMAS, KAYDEN, HORSTEMEYER & RISLEY, LLP/;AT&T BLS Intellectual Property, Inc., 600 GALLERIA PARKWAY, SUITE 1500, ATLANTA, GA, 30339, US

(21) Appl. No.: 11/448,449

(22) Filed: Jun. 6, 2006

(51) Int. Cl. G06F 9/46

(52) U.S. Cl. 705/8

(57) ABSTRACT

Embodiments of the present disclosure provide methods and devices for tracking appointment information. In this regard, one embodiment of such a method, among others, can be broadly summarized by the following steps: maintaining a plurality of appointment records for a plurality of appointments with meeting times that have been arranged in advance, the plurality of appointments scheduled to occur in sequential order such that performance of a second appointment is dependent upon the completion of a first appointment scheduled to occur prior to the second appointment; and after completion of the first appointment, notifying users associated with the plurality of appointments scheduled to occur after the first appointment the performances or which are dependent upon completion of the first appointment, with notification messages having updated meeting times for respective appointments. Other methods and devices are also provided.

### TECHNICAL FIELD

The present disclosure is generally related to scheduling appointments and, more particularly, is related to tracking scheduled appointments.

### BACKGROUND

Appointments are scheduled to accomplish many tasks. For example, a person may schedule an appointment with a cable television technician to install service to the person's home. Often, however, a cable technician will arrive sooner or later to the person's home than the set appointment time. As a result, a person is seemingly often in the dark as to when to realistically expect a technician to arrive at the person's home to perform the requested service, since the initial appointment time is not a very good estimation of the actual arrival time of the technician. This is a general problem that also exists in many contexts, such as waiting at a doctor's office, waiting for a car to be repaired, waiting for a plumber to arrive, waiting for attendees of a meeting to show up, etc.

Thus, a heretofore unaddressed need exists in the industry to address the aforementioned deficiencies and inadequacies.

### SUMMARY

Embodiments of the present disclosure provide methods and devices for tracking appointment information. In this regard, one embodiment of such a method, among others, can be broadly summarized by the following steps: maintaining a plurality of appointment records for a plurality of appointments with meeting times that have been arranged in advance, the plurality of appointments scheduled to occur in sequential order such that performance of a second appointment is dependent upon the completion of a first appointment scheduled to occur prior to the second appointment; and after completion of the first appointment, notifying users associated with the plurality of appointments scheduled to occur after the first appointment the performances or which are dependent upon completion of the first appointment, with notification messages having updated meeting times for respective appointments.

Embodiments also include a computer readable medium having a computer program for performing the above steps. Other methods, devices, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of one embodiment, among others, of a dynamic appointment tracking system 100 for updating and monitoring the progress of appointments.

FIG. 2 is a diagram depicting sample customer profiles and appointment records for one embodiment of a system such as that shown in FIG. 1.

FIG. 3 is a diagram depicting input of appointment information for one embodiment of a system such as that shown in FIG. 1

FIG. 4 is a depiction of one embodiment of a sample appointment record for a system such as that of FIG. 1.

FIG. 5 is a diagram describing a process for updating an appointment within one embodiment of a system such as that of FIG. 1.

FIG. 6 is a diagram depicting a process for updating an appointment time within one embodiment of a system such as that of FIG. 1.

FIG. 7 is a diagram depicting updating of appointment information within one embodiment of a system such as that of FIG. 1.

FIG. 8 is a diagram depicting an embodiment of a notification message being displayed by a user client device such as that of FIG. 1.

FIG. 9 is a diagram of an embodiment of a web page or template for generating an appointment request within a system such as that of FIG. 1.

FIG. 10 is a diagram depicting an embodiment of a notification message being displayed by a user client device such as that of FIG. 1.

FIGS. 11-14 are flow chart describing embodiments of a process for relaying appointment information within a system such as that of FIG. 1.

### DETAILED DESCRIPTION

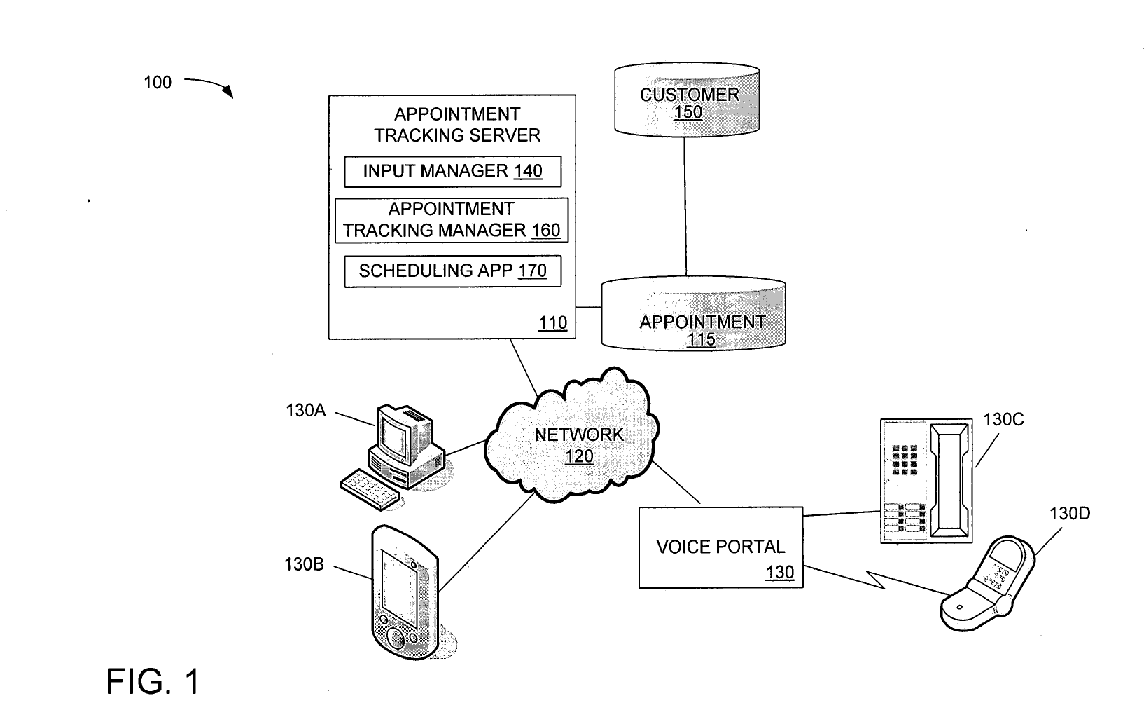

FIG. 1 is a block diagram of one embodiment, among others, of a dynamic appointment tracking system 100 for updating and monitoring the progress of appointments. In accordance with the present disclosure, an appointment is a meeting arranged in advance for a certain time or time range. In one context, the appointment may be a meeting arranged to be held between a customer and a service technician so that the service technician can perform a job for the customer. In another context, the appointment may be a meeting arranged in advance between a customer and a doctor so that the doctor may perform a medical examination of the customer or patient. In another context, the appointment may be a scheduled pickup of a piece of stereo equipment from a repair shop by the owner of the stereo equipment. In another context, the appointment may be a meeting among coworkers or friends. These are just a few examples and are not meant to be limiting. Additional contexts of appointments are discussed hereinafter in the present disclosure. For ease of explanation, the term “appointment” will be used in the description that follows. However, it should be appreciated that this terminology encompasses meetings as well as appointments.

As shown in FIG. 1, one embodiment of the dynamic appointment tracking system 100 includes an appointment server 110 and database 115. The appointment database 115 stores records of appointments. The appointment server 100 and database 115 are accessible from a communication network 120. In one embodiment, the communication network 120 is a network of communication links that are arranged such that communication messages may be passed from one part of the network to another (using gateways such as a wireless data gateway, for example). Accordingly, one part of the communication network 120 may employ a different transmission system and/or communication protocols than another part. Further, more than one type of communication message may be transmitted from one part of the communication network 120 to another part. The communications network 120, in one embodiment, may be the Internet. Otherwise, the communications network, in one embodiment, may be an intranet network. An intranet is restricted and while it may follow the Internet protocol, none or only part of the network may be accessible from the Internet.

Contents of the appointment server 110 and database 115 may be accessed by the user client devices 130A-D. A user client device is a device used to access the appointment server 110 and database 115 and the content therein. In one embodiment, appointment records may be created and/or modified using a user client device 130A-D.

For example, according to one exemplary embodiment, the user client devices 130A-D include a general-purpose computer 130A, a personal digital assistant 130B, etc. that access the appointment database 110 over the communication network 120. Also, a cellular telephone that is capable of Internet communications can access the appointment database 115 using the communications network 120.

Alternatively, input devices not capable of Internet communications may access the appointment server 110 and database 115 via the communication network 120 utilizing a portal or gateway. In one embodiment, a voice portal 130 is used by voice input devices, such as a PSTN (Public Switched Telephone Network) telephone 130C or a cellular telephone 130D.

A voice portal 130 is a server that a user may access by telephone or other voice input device for information maintained in the appointment database 115. For example, a mobile user with a cellular telephone might dial in to a voice portal and request to create or edit an appointment record stored in the appointment database 115 using voice or touchtone keys. A user may also view information from an appointment record stored in the appointment database 115 over a voice channel provided by the voice portal or server 130. The server 130 enables a user to access content in the appointment database 115 by using voice recognition software to communicate the content to the user over a telephone, in one embodiment.

The appointment server 110 may have applications that facilitate the input of information into the appointment database 115. In one embodiment, an input manager 140 may be employed by a person authorized to access the server 110. Via templates or templates or forms on the input manager 140 (such as a web page or software running on a communications device), the input manager 140 may assist a user in providing pertinent information for creating an appointment record or for updating a pre-existing record. In one embodiment, the input manager 140 may be embodied by web pages that are accessed using a web server (not shown).

There are a number of ways that appointment details may be input into the appointment database 115. According to exemplary embodiments, an appointment record is created, where the appointment record contains an identifier for the customer (e.g., his or her address) and an original estimation of a time for the appointment that will be updated as new update information is gathered. Again, the estimated time for the appointment generally means a time that the customer is expecting to receive service of some sort, whether it is the arrival of a technician or the completion of a job, such as a repaired car or dry-cleaned clothes.

Either directly within these records or via pointers to a customer profile, there are preferences as to how that customer wants to be notified throughout the day of the status of his or her appointment. This may be a telephone number, text messaging address, email address, etc. Accordingly, a customer can rank communication addresses in order of priority so that an address (e.g., home telephone number) ranked at a higher priority is attempted to be satisfied over another address that is ranked at a lower priority (e.g., home e-mail address). Customer profile information may be retrieved by the appointment server in creating and updating appointment records. These records or profiles are stored in a customer profile database 150 accessible by the appointment server 100 and database 115.

For the appointment provider (e.g., technician, doctor, mechanic, etc.) that is performing the service requested by the customer which is the subject of the appointment, appointment records for the appointment provider are maintained in an appointment database 115. Therefore, an appointment tracking manager 160 (hosted on the appointments server 110) identifies the appointments that occur in a sequential series for the appointment provider. Further, appointment records are updated with information pertaining to the appointment that is the subject of the record. Therefore, if a job or service request is completed at a time that is earlier than expected, the appointment record may be updated with this information.

For some embodiments, to create or update an appointment record, the input manager 140 may provide data fields to provide certain information (e.g., customer name, customer number, appointment address, meeting time, duration of appointment, etc.) and also provide dropdown lists for specifying certain information (e.g., times, dates, type or nature of appointment, status of appointment, etc.)

For example, in one scenario, a cable television technician may create an appointment record for a service appointment or call that has been scheduled. The appointment record contains information about a particular appointment, such as customer identification, address information where the service is to be performed, initial scheduled time for the appointment, etc. Further, the technician may mark the appointment as being incomplete and list himself or herself as the technician handling the appointment. If an agent for the cable television company set up the appointment, the agent may not immediately assign a technician within the appointment record. This information may be automatically added later by a scheduling application 170 of the appointment server that assigns technicians to appointments based on work schedules of available technicians.

A customer that is requesting the service may also have a profile or record of information that is contained in the appointment database 115 or in another database that is referred as a customer profile database 150, as previously discussed. For example, when a customer initially sets up an appointment, a customer profile may be created for the customer. In the customer profile, the customer is given a unique customer number and the customer's information is stored such as the customer's name, telephone number, address, etc. In addition, preferences of the customer may be stored. In accordance with the present disclosure, one of the types of preferences includes notification preferences, which are described hereinafter.

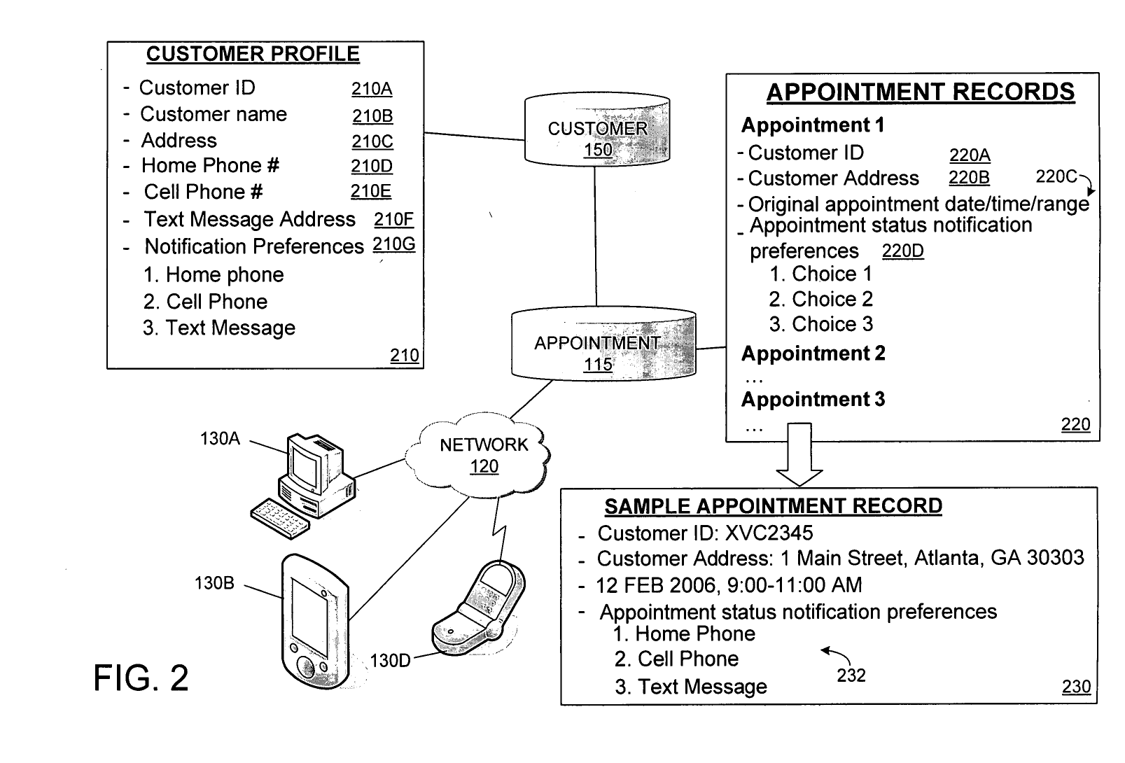

Attention is now directed to FIG. 2 which contains depictions of sample customer profiles and appointment records for one embodiment of the system shown in FIG. 1. In this example, a customer profile 210 contains the following fields: customer identification number 210A, customer name 210B, address 210C, home phone number 210D, cell phone number 210E, text message address 210F, and notification preferences 210G. The customer identification number 210A is a unique number that is assigned to a customer and is used to associate appointment records with the appropriate customer profile. Notification preferences 210F indicate one or more communication addresses or numbers (e.g., instant messaging address, telephone number, e-mail address, short messaging service address, etc.) that are preferred by the customer in receiving notification and updates regarding an appointment. For the sample customer profile 210 shown, it is indicated that the customer prefers to receive a notification via a home telephone 212. If this is unsuccessful, then the customer prefers that the notification is attempted to be delivered via the customer's cell phone. Otherwise, the notification should be attempted to be delivered as a text message to the customer.

The appointment database 115 maintains a plurality of appointment records 220. For each appointment record, in the example shown, a customer identification number 220A, appointment address 220B, original appointment date and time or time range 220C, and appointment notification preferences 220D are contained within the record or are referenced in the record. The customer identification number 220A matches a customer identification number 210A of a customer profile, and the appointment notification preferences 220D are obtained from the notification preferences 210F contained in the customer profile having the customer identification number 220A, 210A.

A sample appointment record 230 is shown. Here, the customer identification number is XVC2345 and the customer resides at 1 Main Street, Atlanta, Ga. 30303. On Feb. 12, 2006, an appointment has been scheduled for 9 A.M. and is expected to take two hours to complete (which will be at 11 A.M.). The notification preferences 232 for the scheduled appointment is to be notified in order of highest priority is via home telephone, cell phone, or text message.

As discussed, the appointment server 110 also has an appointment tracking manager 160. The appointment tracking manager 160 receives update information on a progress of an appointment associated with an appointment record and updates the appointment record with the received update information. Accordingly, the appointment tracking manager 160 also updates appointment records for appointments that are affected by the received update information. Then, the appointment tracking manager 160 sends notification messages to customers whose appointment records have been updated in accordance with the notification preferences contained in the appointment records.

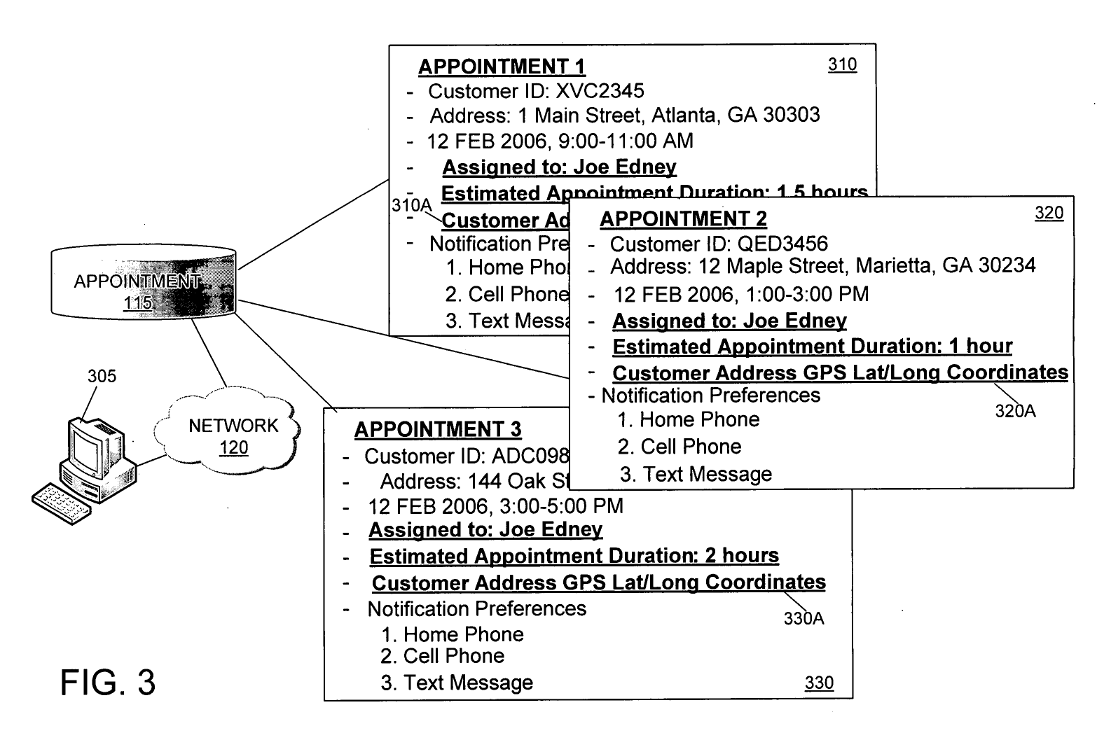

Reference is now directed to FIG. 3. In this example, an agent has input information for three different appointments 310, 320, 330 to be handled by an appointment provider, such as a technician, via a client input device 305. A scheduling application 170 may then assign particular technicians to service the scheduled appointments in accordance with work schedules, work loads, etc of available technicians. The appointment records may be updated with this information as this information is made available. Further, latitude and longitude coordinates 310A, 320A, 330A describing the location of the appointment address may be determined from the customer street address information (via a mapping application, for example) and added to the appointment records. This information may be of use to the technician in gathering directions to the listed address.

In Appointment 1 (310), a technician (“Joe Edney”) is scheduled to arrive at the customer's residence between 9:00 and 11:00 A.M. and the appointment is expected to last 1.5 hours. For Appointment 2 (320), the technician is scheduled to arrive at his or her next appointment between 1:00-3:00 P.M. and the duration of the appointment is expected to be 1 hour. For Appointment 3 (330), the technician is scheduled to arrive at his or her next appointment between 3:00-5:00 P.M. and the duration of the appointment is expected to be 2 hours.

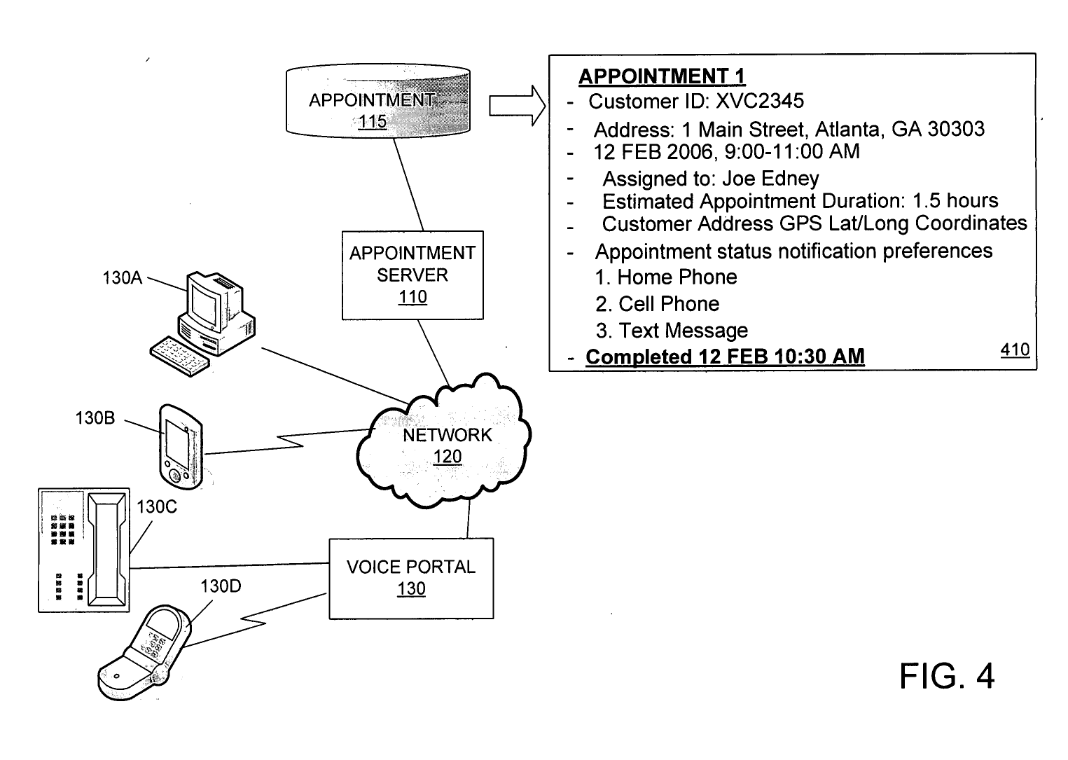

Referring now to FIG. 4, a sample appointment record 410 for Appointment 1 is shown where it is now indicated that the appointment has been completed at 10:30 A.M (410A), where it was originally estimated that the appointment could take until 1:30 P.M. to be completed (11:00 A.M+1.5 hours). To update the appointment record, a technician may access the appointment database 115 via a user client device 130A-D and update the information directly. For example, in one embodiment, a technician may use a personal digital assistant 130B to access a web server (not shown) that is coupled to the appointment server 110 via communication network 120. Using the input manager 140 on the appointment server 110, the technician is presented templates for selecting an appointment record and for updating the data in the selected appointment record. One of the fields may be a status field where the technician can mark the record as being completed. Upon doing so, the record is also time stamped with the time at which the record was marked as being completed by the input manager 140. Alternatively, the technician may relay information to be updated to another person who accesses the appointment record via a client input device.

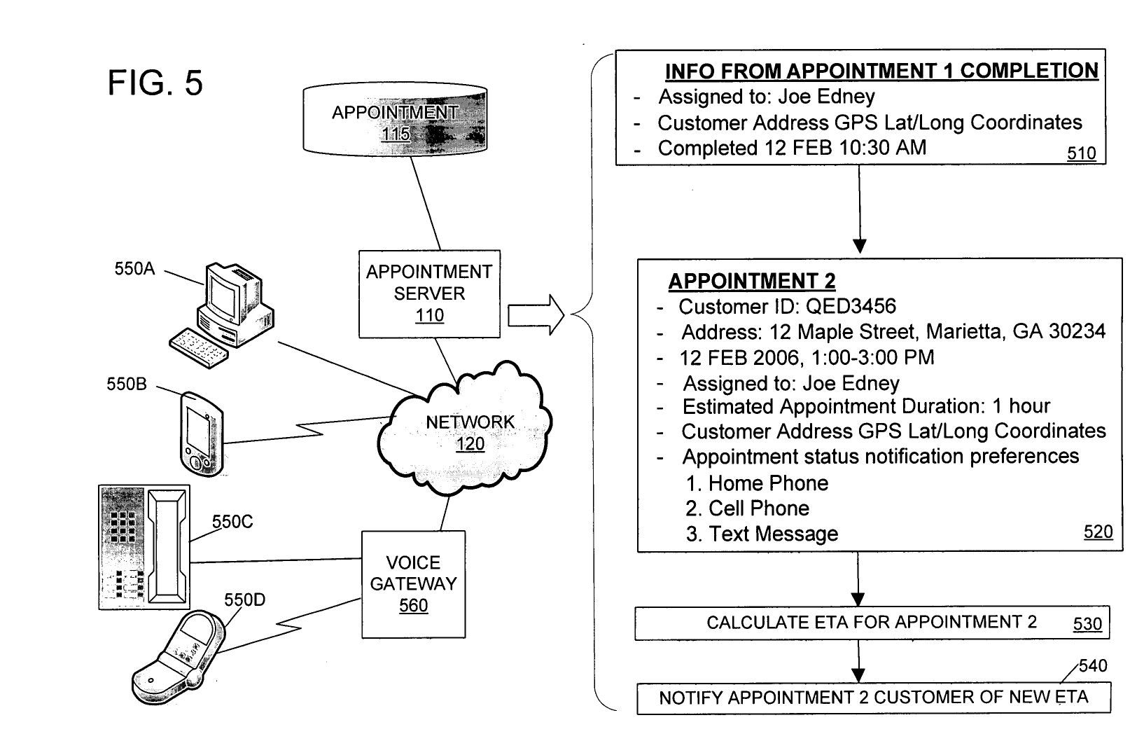

Referring now to FIG. 5, a process for updating an appointment is shown. In box 510, new information has been added to a record for Appointment 1 to indicate that the appointment has been completed at 10:30 A.M. on February 12 by Joe Edney (a technician). Therefore, any other appointments to be handled by Joe Edney on February 12 should also be updated, if necessary. Accordingly, the appointment tracking manager 160 detects the updated information in Appointment 1 which it uses to update information in Appointment 2 that is scheduled to be handled by Joe Edney at a time after the updated appointment. In one embodiment, the input manager 140 may send a message to the appointments tracking manager 160 when a record has been marked as completed. Further, in one embodiment, the appointment tracking manager 160 may periodically run checks on appointment records to determine if any records have been newly marked as being completed since the last time a check was run.

Originally, Appointment 2 is scheduled to be initiated at a time between 1:00-3:00 P.M and is expected to take 1 hour to complete, as indicated in box 520. This estimation was made based on when a prior appointment was expected to be completed. Now, that it is know when Appointment 1 was completed at 10:30 A.M., a more accurate estimate of the arrival time of the technician for Appointment 2 can be made by the appointment tracking manager 160. After the updated arrival time is determined by the appointment tracking manager 160 (as indicated in box 530), the appointment tracking manager 160 sends a notification message to the customer for Appointment 2 to alert him or her of the updated arrival time, as indicated in box 540. As shown in the figure, the notification message may be delivered over a data network 120 to a customer's computer 550A, personal digital assistant 550B, etc. or delivered via a voice gateway 560 over voice channels to voice-based devices, such as PSTN telephone 550C or wireless telephone 550D.

According to exemplary embodiments, many appointments that are serviced by a person are serviced one after the other in an ordered fashion. In other words, there is a scheduled order in how the appointments are serviced. If servicing of one appointment is delayed, then the appointments that are scheduled to be serviced subsequently are also delayed. Accordingly, if servicing of an appointment is advanced or expedited, then appointments that are scheduled to be serviced after the appointment will likely be expedited or advanced. It is advantageous to notify persons having appointments of their changing statuses as they are ascertained.

For example, a prior appointment may be canceled by a customer for that appointment. Accordingly, the appointment that is slated to be handled by the appointment provider next will now likely to be completed at an earlier time. Therefore, the appointment record for the canceled appointment may be updated to reflect the cancellation. The appointment tracking manager 160 may then update the appointments that are next in line to be performed by the appointment provider and notify the respective customer of new estimated appointment times. In a context where the location where the service is to be performed is static or does not change, such as a doctor's office, a dry cleaners, an automobile repair shop, etc., a determination does not have to be made involving a customer's location, since the appointment provider is not required to travel to the customer's location. Alternatively, the location for the appointment may be indicated to be the address of the appointment provider such that a determination of travel time will always be zero since the location of an appointment and the location of a subsequent appointment will be the same.

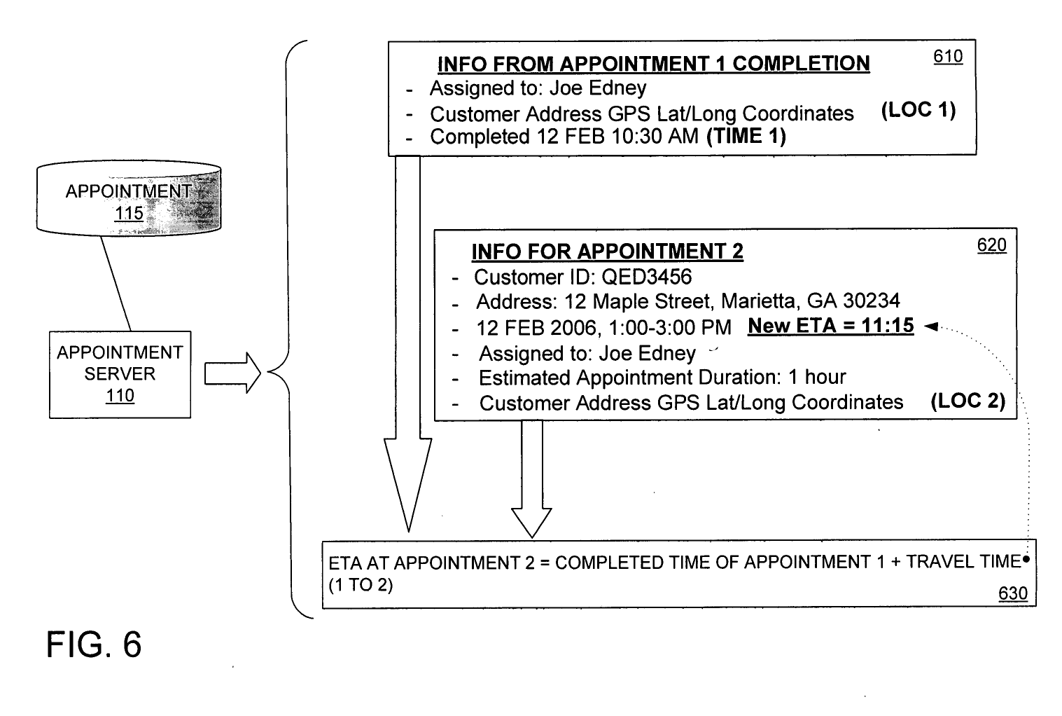

FIG. 6 demonstrates one embodiment for updating an appointment time. In the example shown, information for Appointment 1 has been updated to indicate that the appointment has been completed at 10:30 A.M, as indicated in box 610.

Appointment 2 is originally estimated to be initiated between 1:00 and 3:00 P.M., as indicated in box 620 However, Appointment 1 has completed earlier than expected. Therefore, the appointment time for Appointment 2 may also be earlier than originally expected.

To determine the appointment time for Appointment 2, the travel time from the location where Appointment 1 was performed to the location where Appointment 2 is to be performed is estimated. This methodology is indicated in block 630 where the estimated time of arrival (ETA) for Appointment 2 is a function of the completed time of prior Appointment 1 and the travel time from location 1 (location for Appointment 1) and location 2 (location for Appointment 2). This estimation may be made, in some embodiments, using mapping software where latitude and longitude coordinates for the locations may be entered from appointment records or street address information may be entered.

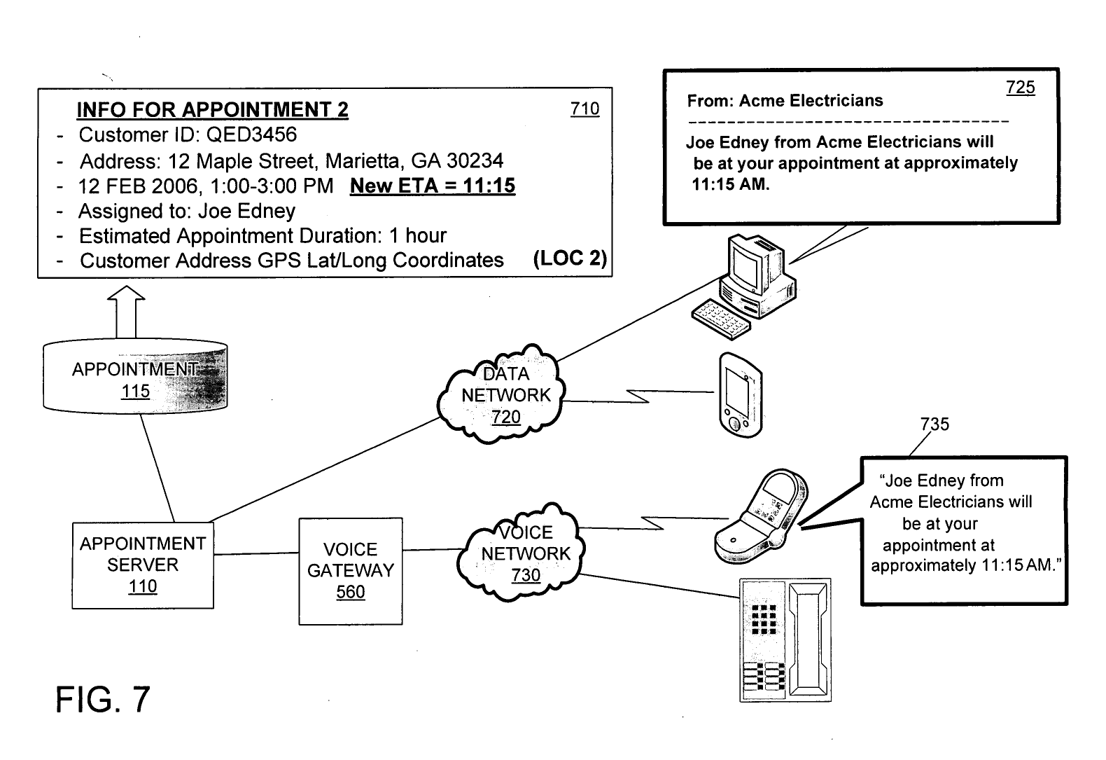

Referring now to FIG. 7, the new estimated time of arrival is added as updated information to the record for Appointment 2 by the appointment tracking manager 170, as indicated in box 710. Accordingly, a notification message 725 may be sent as a text message across a data network 720 to a user device of the customer by the appointment tracking manager 170. Alternatively, a notification message 735 may be sent as a voice message across a voice network 730 to a user device of the customer by the appointment tracking manager 170. The notification message generally informs the user of an updated appointment time.

Therefore, in another context, if a plumber is slated to arrive at a customer's home to do requested work, the customer is provided an initial time or time range that the plumber is estimated to arrive to perform the work. However, as the plumber completes prior jobs or encounters delays or the opposite, the customer is provided updated estimates on the arrival time (e.g., appointment time) throughout the day of the scheduled service. This improves the experience for the customer.

In one embodiment, once an appointment is indicated as being complete, the appointment tracking manager 170 gathers from the appointment record, who the appointment provider is and where the location of the appointment provider is based on information in the appointment record. This information may be updateable by the appointment provider, in some embodiments.

In some embodiments, location information may be GPS (Global Positioning System) coordinates that correspond to a street address of a customer or place of business of an appointment provider that are prestored in the appointment database 115 or obtained realtime via mapping software. GPS coordinates might also be delivered to the system by a user client device that the appointment provider uses to update his or her completion status (e.g., they might mark as complete from a location different from the prior appointment customer address—from the road, at lunch, etc.). An appointment provider could also update if there is some type of delay.

Likewise, in some embodiments, an appointment provider may create an appointment record to delineate that time is being spent on a non-appointment related activity. For example, an appointment provider may complete a first appointment with a customer but have to then perform an errand that is not related to providing a service to a customer. For example, a child of the appointment provider may be sick at school, and the appointment provider needs to take time to pick up the child. Therefore, the appointment provider can create an appointment record for an appointment indicating that the appointment provider has an appointment at 10:00 AM with an expected duration of 1 hour. In creating the appointment, a drop down menu allows the type of appointment to be designated as a “Personal.” In this manner, the appointment time for a second appointment with a customer takes into account the appointment record created so that the appointment provider can handle other matters that do not allow the prevent the provider from promptly servicing the second appointment.

The appointment tracking manager 170 looks up the next scheduled appointment for the appointment provider for that day or within a set range of time (e.g., a six-hour shift). Generally, the appointment provider is indexed by a name or some unique identifier in the appointments records database. The next scheduled appointment is retrieved by the appointment tracking manager 170. It may have different customer information, address, estimated appointment time and duration, and notification preferences. Using the completed time, an updated estimated appointment time is calculated by the appointment tracking manager 170 and the customer is notified of the updated time with an automated message.

Not only is the next customer in line to be serviced by the appointment provider notified, but also the customer after that and perhaps the customers after that, in some embodiments. Accordingly, in some embodiments, appointments that have estimated meeting or appointment times within a certain range (e.g., 6 hours, same workday, service route, etc.) of the updated appointment time are retrieved, updated, and notified of new estimated appointment times.

For example, after a first appointment is completed, the estimated appointment time for the second appointment (that occurs next in order after the first appointment) is updated and the customer for the second appointment is notified. Based on the newly updated appointment time for the second appointment, the appointment time for a third appointment (that occurs next after the second appointment) may also be updated. For example, the appointment time for the third appointment is a function of the appointment time of the second appointment and an estimate of an amount of time needed to complete the appointment plus an estimation of any travel time that is involved between the second and third appointments by the appointment provider (or any other delays that are expected in servicing the appointment).

In some embodiments, the notification message sent to a customer to provide an updated appointment time provides a mechanism for replying or responding to the notification. For example, for a voice message, the message may prompt the customer to “press 1” if the updated appointment time is acceptable to the customer or “press 2” if the updated appointment time is not acceptable to the customer. This could be a case where the updated appointment time no longer falls within a range of time originally estimated for the appointment. Accordingly, if the customer finds the updated time to be unacceptable, then the original range of time may be maintained as the appointment time, if possible. In the case where the updated time occurs after the original range of time and the customer indicates that the updated time is unacceptable, then the appointment may be canceled. In such a case, a customer may be automatically forwarded to a person or interactive voice response (IVR) menu for scheduling a new appointment.

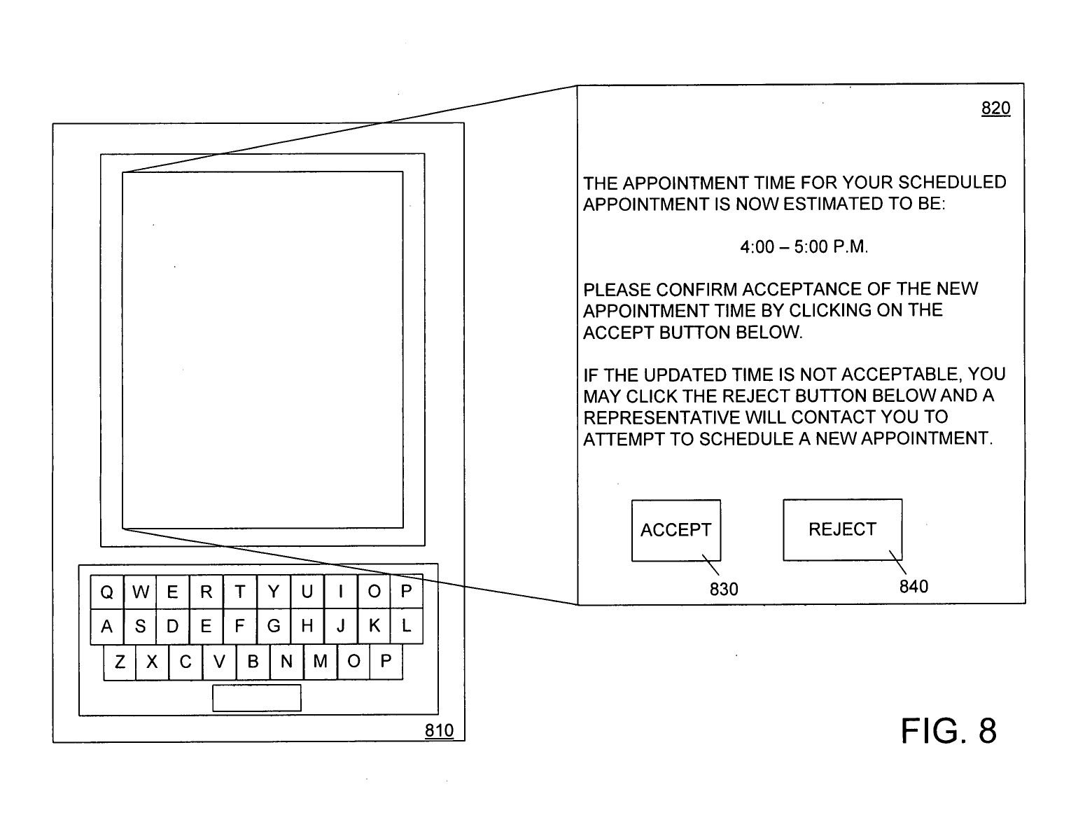

Similarly, for a text message, the message may contain instructions for responding to the message to indicate whether an updated appointment time is acceptable in a similar manner as the voice message approach. Likewise, the notification message or one of subsequent replies to the customer may provide instructions for scheduling a new appointment time (e.g., calling an IVR system or accessing a web interface). For example, FIG. 8 shows a user client device 810 displaying a notification message 820. In the message 820, a user is instructed or prompted to select an Acceptance button 830 to confirm acceptance of an updated appointment time or to select a Reject button 840 to indicate that the updated time is not acceptable.

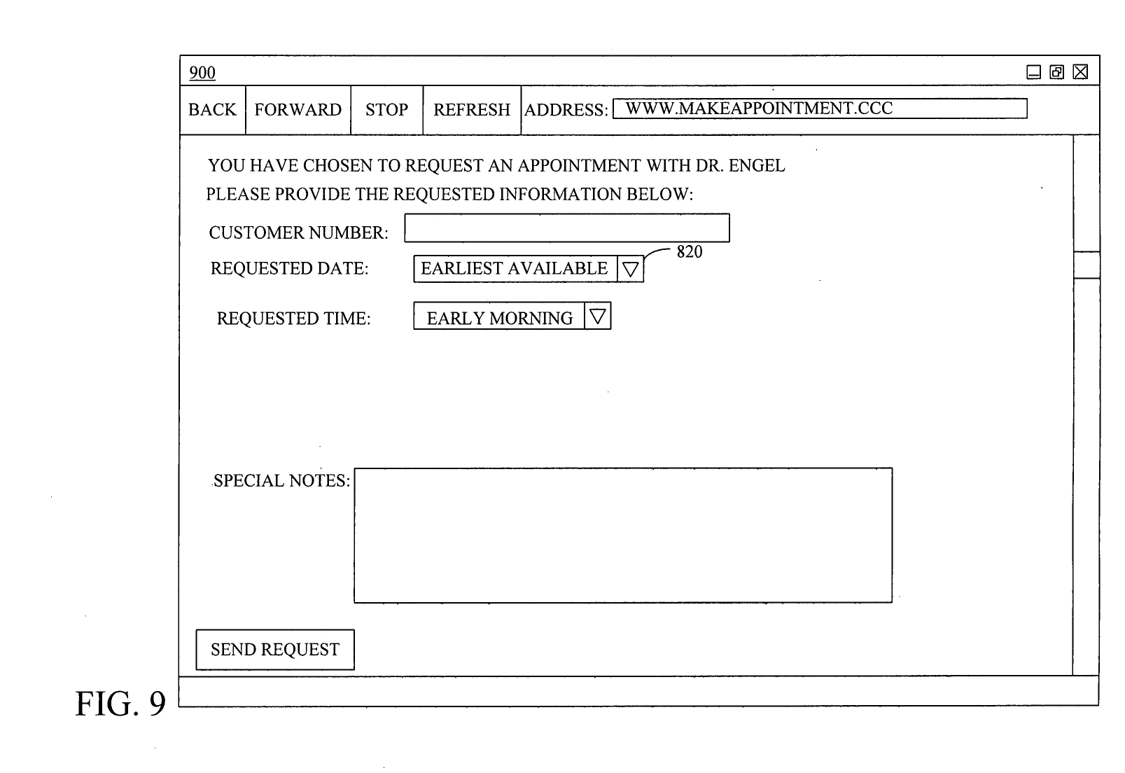

In some embodiments, a customer may access web pages from a web server (not shown) that enable the customer to schedule a new appointment. For example, a provider of a service may enable a customer to go to a web site sponsored by the provider that allows the customer to request an appointment with a service provider (e.g., plumber, mechanic, landscape artist, etc.) for a certain time (1:00 P.M., a.s.a.p., this week, etc.). Further, the web site may utilize a template to facilitate selecting the service being requested; the requested appointment time and date; and additional criteria (via dropdown lists), and notes or comments (via a box for typing free form text). An example web page or template 900 for generating an appointment request is shown in FIG. 9.

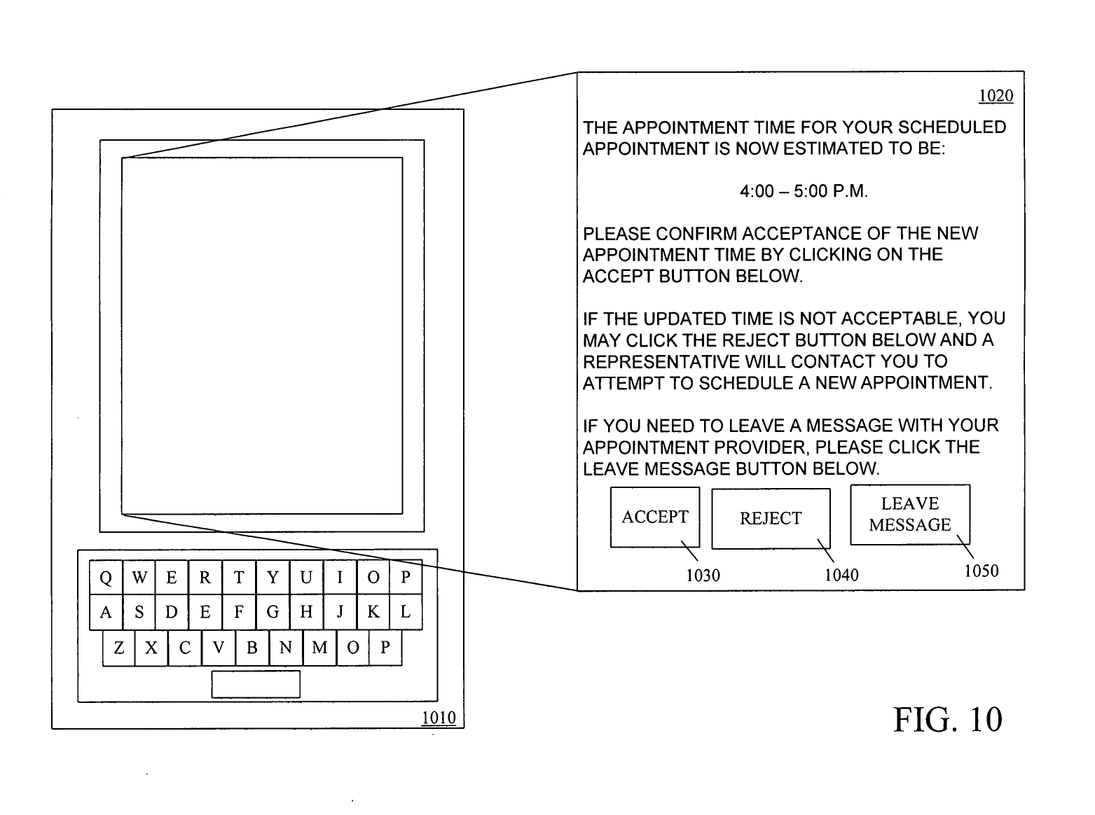

Also, in some embodiments, the notification message may provide a mechanism for communicating directly with the appointment provider servicing the appointment. For example, for a voice message, the customer may be prompted to “Press 3” if you would like to leave a voice mail message for the appointment provider. In this way, a customer could record a message to let the appointment provider know that the customer may be a little late in returning from an errand. Likewise, text-based messages may be sent to the appointment provider to inform the appointment provider of information that is pertains to the job to be performed by the appointment provider. For example, FIG. 10 shows a user client device 1010 displaying a notification message 1020. In the message 1020, a user is instructed or prompted to select an Acceptance button 1030 to confirm acceptance of an updated appointment time or to select a Reject button 1040 to indicate that the updated time is not acceptable. Further, the user may leave a message with the appointment provider by selecting the Leave a Message button 1050.

Teachings of the present disclosure are not limited to a context where a technician or service person is scheduled to perform a service call at an off-site location, such as a customer's residence. For example, consider a business where a customer is given an estimate as to when a particular job is to be completed. This could be a time provided by a dry cleaner as to when a customer's clothes will be ready for pick up; this could be a time provided by an auto mechanic as to when a customer's car will be ready; or this could be a time provided by a hair stylist as to when the stylist's first five appointments are to be completed where the customer is slated to be the sixth appointment, as but a few examples.

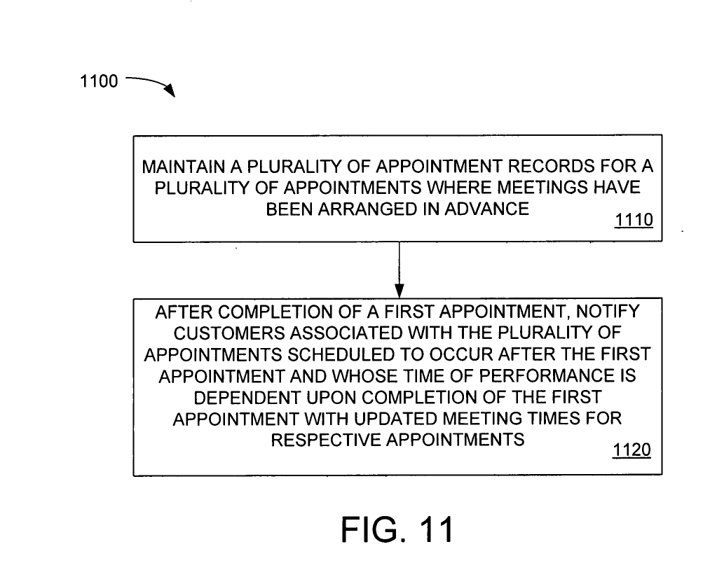

Referring now to FIG. 11, one embodiment, among others, of a process (1100) for relaying appointment information is described. The process includes the step of maintaining (1110) a plurality of appointment records for a plurality of appointments where meetings have been arranged in advance. The plurality of appointments are scheduled to occur in sequential order such that performance of a second appointment is dependent upon the completion of a first appointment scheduled to occur prior to the second appointment. After completion of the first appointment, customers associated with the plurality of appointments scheduled to occur after the first appointment and whose time of performance is dependent upon completion of the first appointment are notified (1120) with notification messages having updated meeting times for respective appointments.

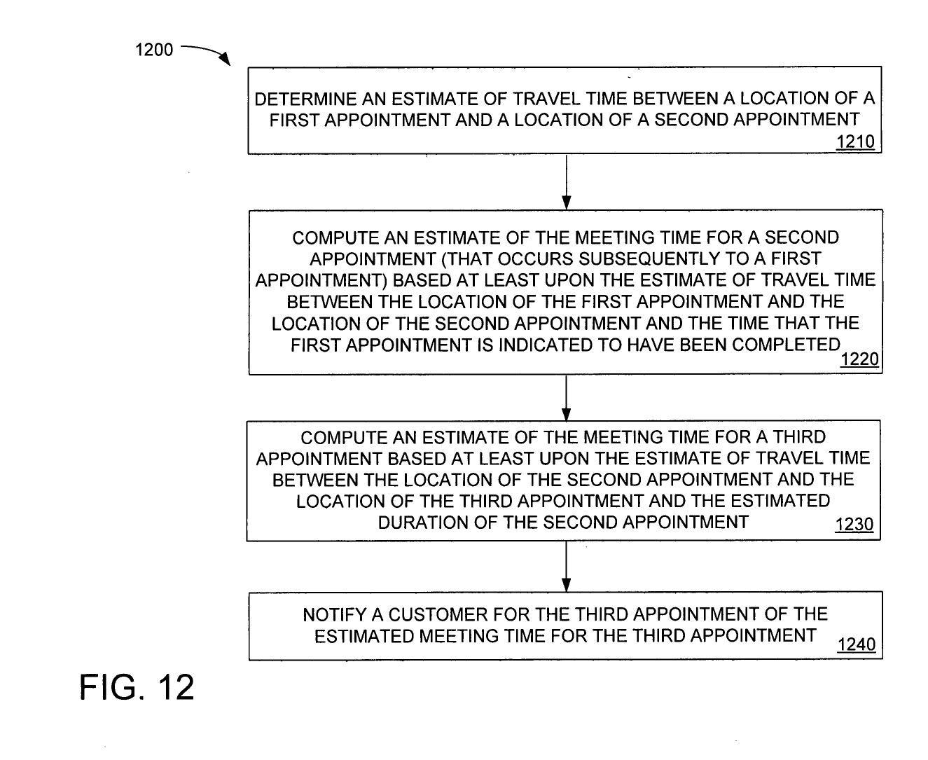

FIG. 12 is one embodiment, among others, of a process (1200) for relaying appointment information. The process includes the step of determining (1210) an estimate of travel time between a location of a first appointment and a location of a second appointment. An estimate of the meeting time for a second appointment (that occurs subsequently to a first appointment) is computed (1220) based at least upon the estimate of travel time between the location of the first appointment and the location of the second appointment and the time that the first appointment is indicated to have been completed. An estimate of the meeting time for a third appointment is computed (1230) based at least upon the estimate of travel time between the location of the second appointment and the location of the third appointment and the estimated duration of the second appointment. A customer for the third appointment is notified (1240) of the estimated meeting time for the third appointment.

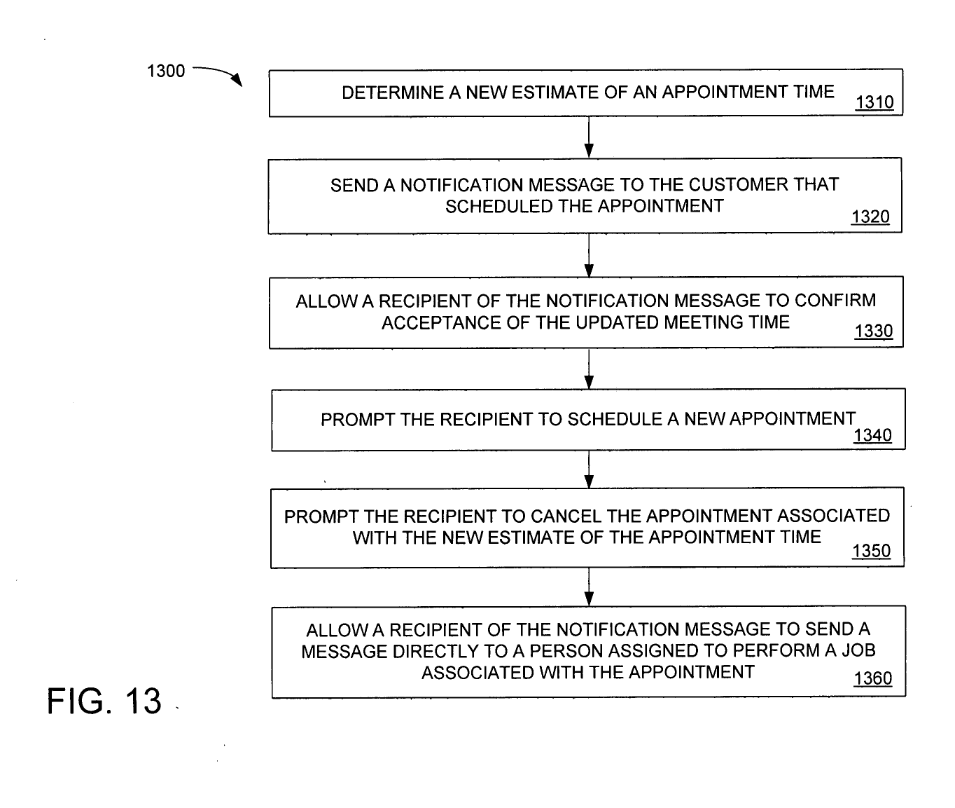

Referring now to FIG. 13, one embodiment, among others, of a process (1300) for relaying appointment information is described. The process includes the step of determining (1310) a new estimate of an appointment time. A notification message is sent (1320) to the customer that scheduled the appointment and is enabled to allow (1330) a recipient of the notification message to confirm acceptance of the updated meeting time. If the recipient does not confirm acceptance of the new estimate of the appointment time, the recipient is prompted (1340) to schedule a new appointment. Alternatively, the recipient is prompted to cancel (1350) the appointment associated with the new estimate of the appointment time if the recipient does not approve of the new appointment time. Further, the notification message is enabled to allow (1360) a recipient of the notification message to send a message directly to a person assigned to perform a job associated with the appointment.

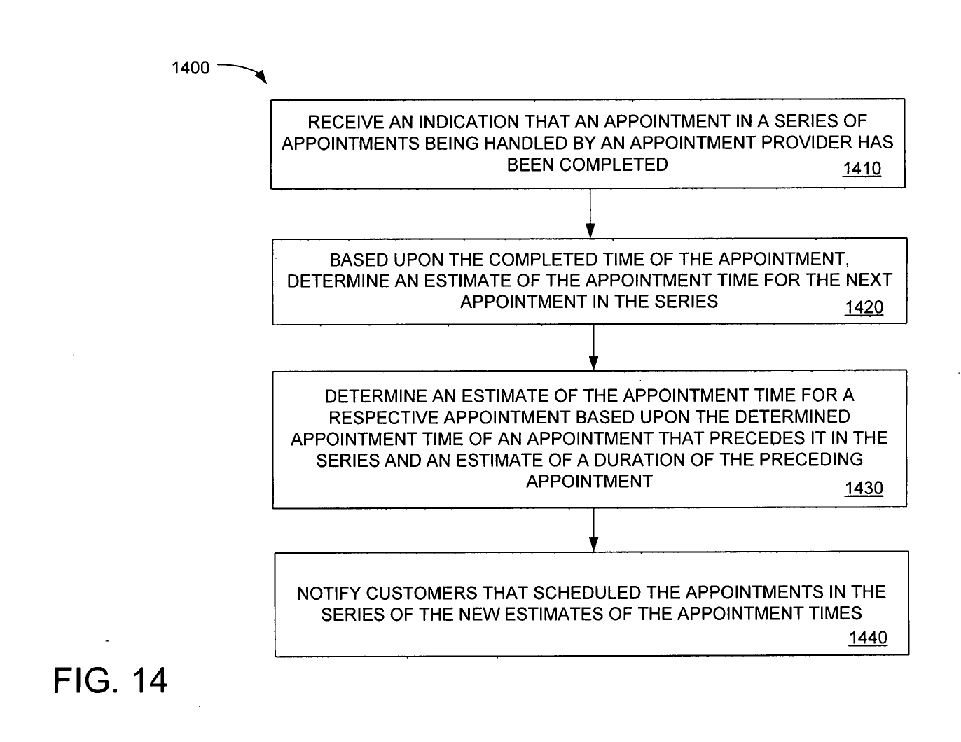

FIG. 14 is one embodiment, among others, of a process (1400) for relaying appointment information. The process includes the step of receiving (1410) an indication that an appointment in a series of appointments being handled by an appointment provider has been completed. Based upon the completed time of the appointment, an estimate of the appointment time for the next appointment in the series is determined (1420). Accordingly, for all the other appointments in the series, an estimate of the appointment time for a respective appointment is determined (1430) based upon the determined appointment time of an appointment that precedes it in the series and an estimate of a duration of the preceding appointment. Customers that scheduled the appointments in the series are then notified (1440) of the new estimates of the appointment times.

Certain embodiments of the present disclosure can be implemented in hardware, software, firmware, or a combination thereof. In some embodiments, for example, input manager 140, the appointment tracking manager 160, scheduling application 170, etc. is implemented in software or firmware that is stored in a memory and that is executed by a suitable instruction execution system. If implemented in hardware, as in an alternative embodiment, the input manager 140, the appointment tracking manager 160, scheduling application 170, etc. can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing steps in a process or as modules, segments, or portions of code which include one or more executable instructions for implementing specific logical functions, and alternate implementations are included within the scope of selected embodiments of the present disclosure in which functions may be executed out of order from that shown or discussed, including substantially concurrently or in reverse order, depending on the functionality involved, as would be understood by those reasonably skilled in the art of the present disclosure.

The appointment tracking manager 160 and other components of the dynamic appointment tracking system 100, in some embodiments, comprise an ordered listing of executable instructions for implementing logical functions, which can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of the present disclosure includes embodying the functionality of the preferred embodiments of the present disclosure in logic embodied in hardware or software-configured mediums.

It should be emphasized that the above-described embodiments of the present disclosure are merely possible examples of implementations, merely set forth for a clear understanding of the principles of the disclosures. Many variations and modifications may be made to the above-described embodiments without departing substantially from the spirit and principles of the disclosure. All such modifications and variations are intended to be included herein within the scope of this disclosure.

Therefore, having thus described the invention, at least the following is claimed:

1. A method for tracking appointment information, comprising the steps of:
maintaining a plurality of appointment records for a plurality of appointments with meeting times that have been arranged in advance, the plurality of appointments scheduled to occur in sequential order such that performance of a second appointment is dependent upon the completion of a first appointment scheduled to occur prior to the second appointment; and
after completion of the first appointment, notifying users associated with the plurality of appointments scheduled to occur after the first appointment the performances or which are dependent upon completion of the first appointment, with notification messages having updated meeting times for respective appointments.

2. The method of claim 1, further comprising the step of:
maintaining notification preferences for a user indicating preferred addresses for notifying the user with changes in appointment information for the user.

3. The method of claim 1, further comprising the steps of:
receiving an indication that an appointment that is a subject of an appointment record is canceled; and
updating the appointment record as being canceled, wherein appointment records of appointments that occur subsequently to the canceled appointment are updated with new estimates of meeting times.

4. The method of claim 1, further comprising the steps of:
determining an estimate of travel time between a location of the first appointment and a location of the second appointment; and
computing an estimate of a meeting time for the second appointment based at least upon the estimate of travel time between the location of the first appointment and the location of the second appointment.

5. The method of claim 4, further comprising the step of:
computing an estimate of a meeting time for a third appointment based at least upon the estimate of travel time between the location of the second appointment and the location of the third appointment.

6. The method of claim 1, further comprising the step of:
enabling a notification message having an updated meeting time to allow a recipient of the notification message to confirm acceptance of the updated meeting time.

7. The method of claim 6, further comprising the step of:
prompting the recipient to schedule a new appointment meeting time if the recipient does not confirm acceptance of the updated meeting time.

8. The method of claim 7, further comprising the step of:
prompting the recipient to cancel the appointment associated with the updated meeting time.

9. The method of claim 1, comprising the step of:
enabling a notification message having an updated meeting time to allow a recipient of the notification message to send a message directly to a person assigned to perform a job associated with the appointment.

10. The method of claim 1, wherein the plurality of appointment records have been assigned to a common person, the method further comprising the step of:
receiving instructions from the person to create a record indicating that time is being allocated to a new event; and
upon creation of the record, notifying customers associated with the plurality of appointments scheduled to occur after the new event and whose performance is dependent upon completion of the new event with notification messages having updated meeting times for respective appointments.

11. A computer readable medium having a computer program for tracking appointment information, the program having instructions for performing the steps of:
maintaining a plurality of appointment records for a plurality of appointments with meeting times that have been arranged in advance, the plurality of appointments scheduled to occur in sequential order such that performance of a second appointment is dependent upon the completion of a first appointment scheduled to occur prior to the second appointment; and
after completion of the first appointment, notifying users associated with the plurality of appointments scheduled to occur after the first appointment the performances or which are dependent upon completion of the first appointment, with notification messages having updated meeting times for respective appointments.

12. The computer readable medium of claim 11, the program further performing the step of:
maintaining notification preferences for a user indicating preferred addresses for notifying the user with changes in appointment information for the user.

13. The computer readable medium of claim 11, the program further performing the steps of:
receiving an indication that an appointment that is a subject of an appointment record is canceled; and
updating the appointment record as being canceled, wherein appointment records of appointments that occur subsequently to the canceled appointment are updated with new estimates of meeting times.

14. The computer readable medium of claim 11, the program further performing the steps of:
determining an estimate of travel time between a location of the first appointment and a location of the second appointment; and
computing an estimate of a meeting time for the second appointment based at least upon the estimate of travel time between the location of the first appointment and the location of the second appointment.

15. The computer readable medium of claim 14, the program further performing the step of:
computing an estimate of a meeting time for a third appointment based at least upon the estimate of travel time between the location of the second appointment and the location of the third appointment.

16. The computer readable medium of claim 14, the program further performing the step:
enabling a notification message having an updated meeting time to allow a recipient of the notification message to confirm acceptance of the updated meeting time.

17. The computer readable medium of claim 16, the program further performing the step of:
prompting the recipient to schedule a new appointment meeting time if the recipient does not confirm acceptance of the updated meeting time.

18. The computer readable medium of claim 17, the program further performing the step of:
prompting the recipient to cancel the appointment associated with the updated meeting time.

19. The computer readable medium of claim 18, the program further performing the step of:
enabling a notification message having an updated meeting time to allow a recipient of the notification message to send a message directly to a person assigned to perform a job associated with the appointment.

20. The computer readable medium of claim 19, wherein the plurality of appointment records have been assigned to a common person, the program further performing the step of:
receiving instructions from the person to create a record indicating that time is being allocated to a new event; and
upon creation of the record, notifying customers associated with the plurality of appointments scheduled to occur after the new event and whose performance is dependent upon completion of the new event with notification messages having updated meeting times for respective appointments.
